(19) United States
(12) Patent Application Publication
(10) Pub. No.: US 2020/0086738 A1
(43) Pub. Date: Mar. 19, 2020

(54) VEHICLE FUEL INLET ASSEMBLY THAT FACILITATES OUTER PANEL REMOVAL AND OUTER PANEL REMOVAL METHOD

(71) Applicant: Ford Global Technologies, LLC, Dearborn, MI (US)

(72) Inventors: Jack Marchlewski, Saline, MI (US); Robert Reiners, Grosse Ile, MI (US); Darrin Neil Wagner, Bloomfield Hills, MI (US); Duncan Whipps, Grosse Pointe Farms, MI (US)

(21) Appl. No.: 16/133,848

(22) Filed: Sep. 18, 2018

(51) Int. Cl. B60K 15/04; B60K 15/05; B62D 65/02; B62D 25/02; B62D 27/06

(52) U.S. Cl. CPC B60K 15/04; B60K 15/05; B62D 65/02; B60K 2015/0474; B62D 27/06; B60K 2015/053; B60K 2015/0561; B62D 25/02

(57) ABSTRACT

A vehicle assembly includes, among other things, a first and a second housing of a fuel inlet assembly. The first housing is securable to an outer panel of a vehicle. A fuel inlet fastener connects together the first and second housings. The fuel inlet fastener is configured to be accessed through a fuel inlet aperture of the outer panel to disconnect the first housing from the second housing. A panel removal method includes disconnecting a first and second housing of a fuel inlet assembly through a fuel inlet aperture in an outer panel of a vehicle. The method further includes removing the outer panel and the first housing from the vehicle.

### TECHNICAL FIELD

This disclosure relates generally to a fuel inlet assembly and, more particularly, to a fuel inlet assembly that simplifies removal of an outer panel from a vehicle.

### BACKGROUND

Vehicles include outer panels. Users may periodically remove and replace the outer panels. The replacement could be for aesthetic reasons, due to damage, or for some other reason. Users may replace outer panels to provide their vehicle with a more rugged appearance, for example, or to equip their vehicle with outer panels that are better suited to off-roading.

Replacing outer panels can be complicated and time consuming. Further, replacing outer panels that provide a fuel inlet to a fuel tank of the vehicle can be particularly difficult. To replace such an outer panel, the user may be required to access areas behind the outer panel to disconnect components of a fuel inlet assembly from the outer panel, another portion of the vehicle, or both.

### SUMMARY

A vehicle assembly according to an exemplary aspect of the present disclosure includes, among other things, a first and a second housing of a fuel inlet assembly. The first housing is securable to an outer panel of a vehicle. A fuel inlet fastener connects together the first and second housings. The fuel inlet fastener is configured to be accessed through a fuel inlet aperture of the outer panel to disconnect the first housing from the second housing.

A further non-limiting embodiment of the foregoing assembly includes a fuel door pivotably secured to the first housing.

In a further non-limiting embodiment of any of the foregoing assemblies, the fuel door is lockable in when in a closed position.

A further non-limiting embodiment of any of the foregoing assemblies includes a fuel inlet pipe at least partially received within the second housing.

In a further non-limiting embodiment of any of the foregoing assemblies, the first housing is an outer housing and the second housing is an inner housing.

In a further non-limiting embodiment of any of the foregoing assemblies, the first housing is clipped to the outer panel to secure the first housing to the outer panel.

In a further non-limiting embodiment of any of the foregoing assemblies, the first housing can be removed from the vehicle with the outer panel when the first housing is disconnected from the second housing.

In a further non-limiting embodiment of any of the foregoing assemblies, the outer panel is a rear quarter panel of the vehicle.

A further non-limiting embodiment of any of the foregoing assemblies includes a connector assembly mounted on the second housing such that the first housing can be disconnected from the second housing without decoupling the connector assembly.

In a further non-limiting embodiment of the foregoing assembly, the fuel inlet fastener comprises at least one mechanical fastener.

A panel removal method according to another exemplary aspect of the present disclosure includes disconnecting a first and second housing of a fuel inlet assembly through a fuel inlet aperture in an outer panel of a vehicle. The method further includes removing the outer panel and the first housing from the vehicle.

A further non-limiting embodiment of the foregoing method includes, prior to the removing, disengaging panel fasteners that secure the outer panel to the vehicle.

In a further non-limiting embodiment of any of the foregoing methods, the disconnecting includes disengaging a fuel inlet fastener that connects together the first and second housings.

A further non-limiting embodiment of any of the foregoing methods includes disengaging the fuel inlet fastener without directly interfacing with an area behind the first housing.

In a further non-limiting embodiment of any of the foregoing methods, the fuel inlet fastener is a mechanical fastener.

A further non-limiting embodiment of any of the foregoing methods includes installing a replacement outer panel and a replacement first housing. The installing includes securing the replacement first housing to the second housing.

In a further non-limiting embodiment of any of the foregoing methods, the first housing is secured to the outer panel during the removing.

In a further non-limiting embodiment of any of the foregoing methods, the first housing is snap-fit to the outer panel during the removing.

In a further non-limiting embodiment of any of the foregoing methods, the first housing is an outer housing that is secured to the outer panel, and the second housing is an inner housing that interfaces directly with a fuel pipe.

### DESCRIPTION OF THE FIGURES

The various features and advantages of the disclosed examples will become apparent to those skilled in the art from the detailed description. The figures that accompany the detailed description can be briefly described as follows:

FIG. 1 illustrates a perspective view of an example vehicle.

FIG. 2 illustrates a close-up view of a fuel inlet assembly and a fuel inlet aperture provided in an outer panel of the vehicle.

FIG. 3 illustrates another view of the outer panel of FIG. 2 along with a schematically represented fuel tank of the FIG. 1 vehicle.

FIG. 4 illustrates a section view taken at line 4-4 in FIG. 2.

FIG. 5 illustrates a front view of a first housing of the fuel inlet assembly of FIG. 2.

FIG. 6 illustrates a perspective view of the outer panel and the first housing of the fuel inlet assembly of FIG. 2 removed from other portions of the vehicle.

FIG. 7 illustrates a section taken at the position of FIG. 4 when the outer panel and first housing are in the position of FIG. 6.

FIG. 8 illustrates a section taken at the position of FIG. 7 when a replacement panel and replacement first housing are being moved toward an installed position with the vehicle.

FIG. 9 illustrates a perspective view of the replacement panel and replacement first housing in an installed position on the vehicle.

FIG. 10 illustrates a section view taken at line 10-10 in FIG. 9.

### DETAILED DESCRIPTION

This disclosure relates generally to a fuel inlet assembly and, more particularly, a fuel inlet assembly that facilitates replacing an outer panel of a vehicle.

The fuel inlet assembly includes a first housing that can be secured to an outer panel of a vehicle, and a second housing that connects to the first housing. The fuel inlet assembly can provide a passage from a fuel inlet aperture in the outer panel to a fuel inlet tube of the vehicle. A user can access fuel inlet fasteners that connect together the first and second housing through the fuel inlet aperture. Although the first housing is secured to the outer panel, the user does not have to undertake complicated disconnections behind the outer panel to remove the outer panel from the vehicle.

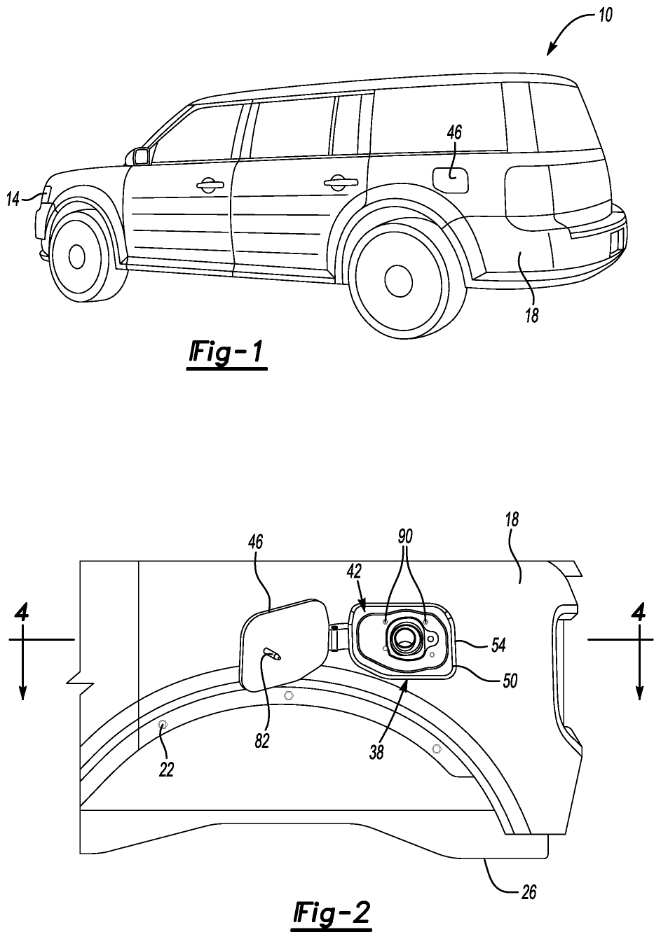

With reference to FIG. 1, an example vehicle 10 includes a plurality of outer panels 14, 18. The outer panel 14 is a front fender of the vehicle 10. The outer panel 18 is a rear quarter panel of the vehicle 10.

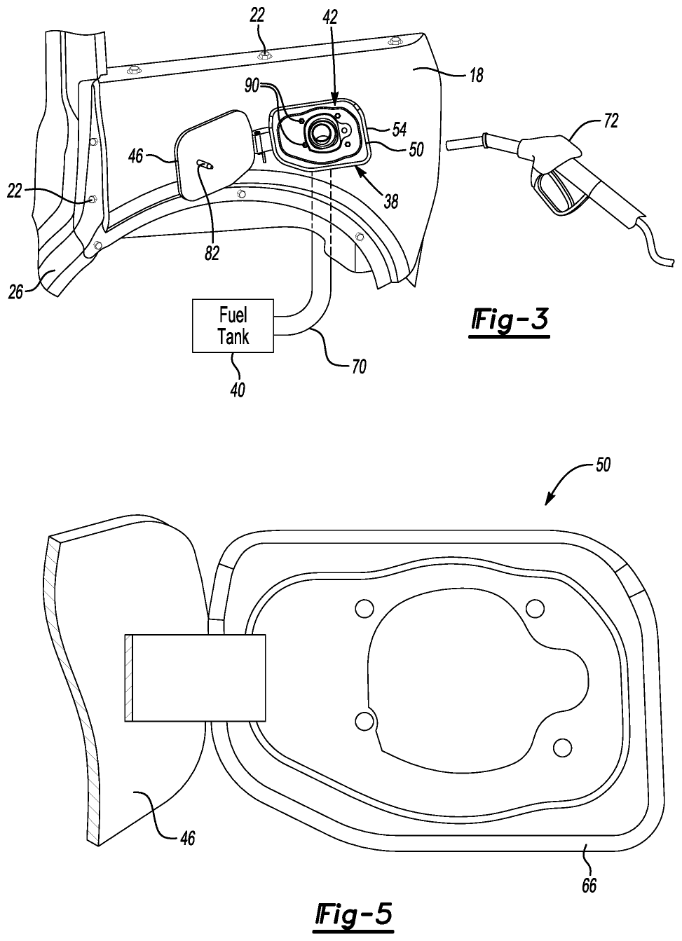

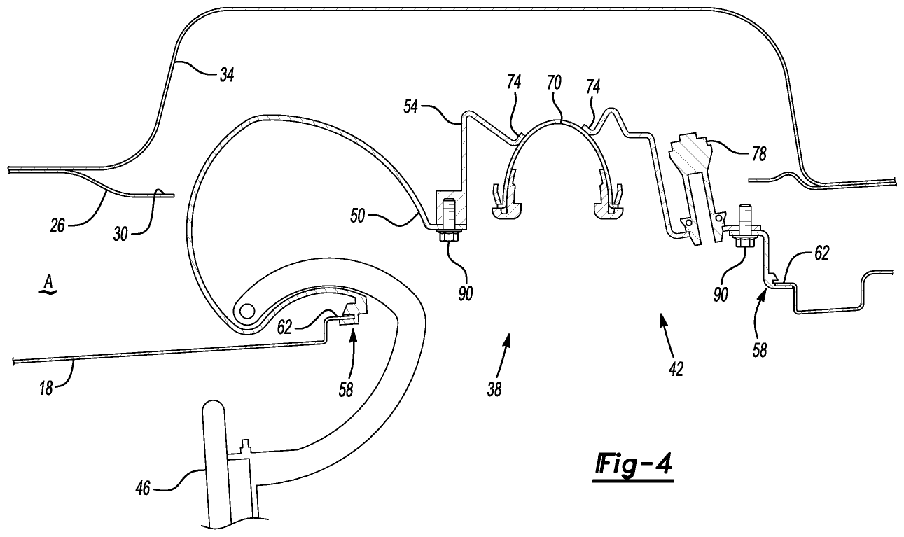

With reference now to FIGS. 2-5 and continuing reference to FIG. 1, a plurality of panel fasteners 22 secure the outer panel 18 to the vehicle 10. In this example, the panel fasteners 22 are mechanical fasteners, such as bolts, that secure the outer panel 18 relative to an inner panel 26 of the vehicle. The inner panel 26 includes, among other things, a body side inner panel 30 and a wheelhouse inner panel 34.

The outer panel 18 provides a fuel inlet aperture 38. A user can refill a fuel tank 40 of the vehicle 10 through the fuel inlet aperture 38 of the outer panel 18.

A fuel inlet assembly 42 is disposed adjacent the fuel inlet aperture 38. The fuel inlet assembly 42 includes, among other things, a fuel door 46, a first housing 50, and a second housing 54. The fuel inlet assembly 42 can be installed to the vehicle 10 through the fuel inlet aperture 38 during initial assembly of the vehicle 10. The fuel inlet assembly 42 provides a “capless” fuel housing in this example.

The fuel door 46 is pivotably secured to the first housing 50. The fuel door 46 can move between the open position shown and a closed position (FIG. 1) where the fuel door 46 fits within the fuel inlet aperture 38 of the outer panel 18.

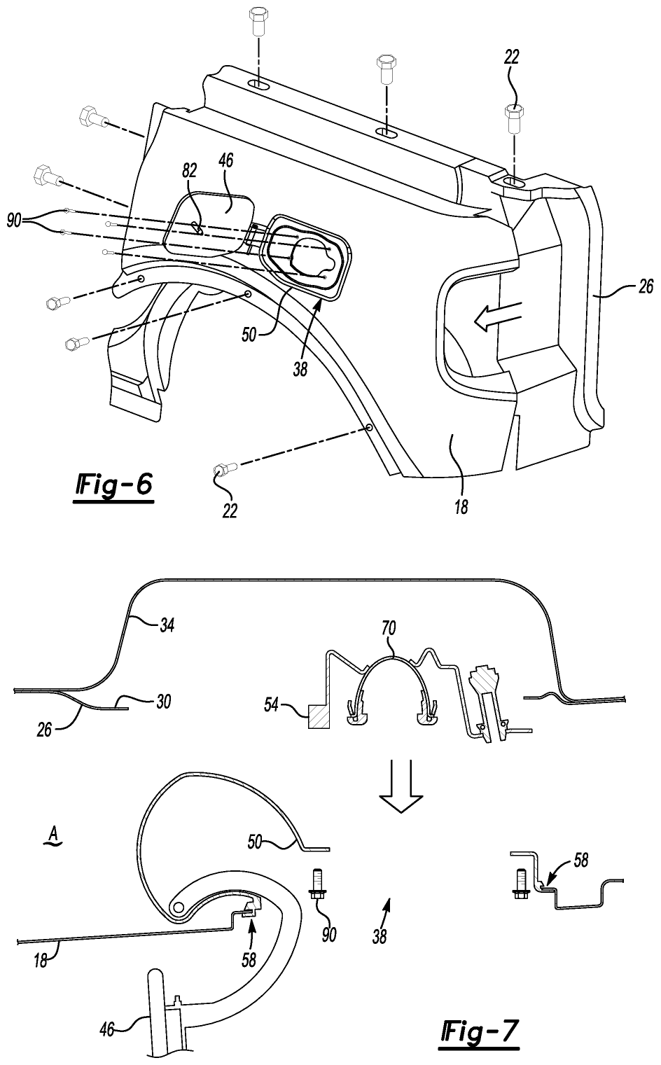

The first housing 50 is, relative to the vehicle 10, an outer housing, and the second housing 54 is an inner housing. When installed, the first housing 50 is secured to the outer panel 18. In this example, clips 58 of the first housing 50 receive a corresponding flange portion 62 of the outer panel 18 to secure the first housing 50. The clips 58 may extend about a circumferential perimeter of the first housing 50. The clips 58, in this example, snap-the first housing 50 to the outer panel 18. A seal 66 (FIG. 6) can be fit over portions of the clips 58 to block debris from moving through the interface between the clips 58 and the flange 62.

The second housing 54 interfaces with, and in this example, at least partially receives a fuel pipe 70 that extends to the fuel tank 40 of the vehicle 10. To refill the fuel tank 40 with fuel, a user can insert a fuel nozzle 72 through the fuel inlet aperture 38 and then direct fuel into the fuel pipe 70. The fuel flows through the fuel pipe 70 to the fuel tank 40 of the vehicle 10.

The second housing 54 can include flexible portions 74 that directly contact the fuel pipe 70 to block debris from moving between the interfaces between the flexible portion 74 and the fuel pipe 70. The flexible portions 74 may be a rubber boot, for example, that friction fits to the fuel pipe 70.

A connector assembly 78 is secured to the second housing 54. The connector assembly 78 can include electrical connectors and can couple a manual fuel door release and a door locking solenoid to vehicle systems, for example. The manual fuel door release and door locking solenoid may be required for a Non-Integrated Refueling Canister Only System (NIRCOS), which are typically used on hybrid electric vehicles (HEVs).

The NIRCOS is a sealing system that can contain fuel vapors when the user is not refilling the fuel tank 40 of the vehicle. A NIRCOS pin 82 extends from the fuel door 46 in this example. When the fuel door 46 is closed, the NIRCOS pin 82 fits within a bore 86. The door locking solenoid of the electrical connectors can hold the NIRCOS pin 82 within the bore 86 to hold the fuel door 46 in a closed position. Wiring for the locking solenoid and a manual override fuel door release cable can terminate within the connector assembly 78.

The first housing 50 is connected to the second housing 54 via a plurality of fuel inlet fasteners 90. In this example, the fuel inlet fasteners 90 are mechanical fasteners. Other fuel inlet fasteners 90 could be used in other examples, such as pins, fir-tree attachments, etc.

The heads of the example fuel inlet fasteners 90 can be accessed through the fuel inlet aperture 38 of the outer panel 18. That is, a user can insert a tool through the fuel inlet aperture 38 and engage the heads of the fuel inlet fasteners 90. The tool can then be used to rotate the fuel inlet fasteners 90 until the first housing 50 is disconnected from the second housing 54.

Notably, the user is not required to interface with an area A behind the outer panel 18 in order to disconnect the first housing 50 from the second housing 54. This provides a simplified disconnection strategy over techniques that would require the user to access the area A when disconnecting the first housing 50 from the second housing 54.

To remove the outer panel 18 for repair or replacement as shown in FIG. 6, a user disengages the fuel inlet fasteners 90 by accessing the fuel inlet fasteners 90 through the fuel inlet aperture 38. The user also disengages the panel fasteners 22. The user is not required to interact with areas A behind the outer panel 18 in order to disengage the panel fasteners 22 or the fuel inlet fasteners 90.

After disengaging the fuel inlet fasteners 90 and the panel fasteners 22, the outer panel 18 and the first housing 50 can be moved away from the vehicle as shown in FIGS. 6 and 7. Since the connector assembly 78 is secured to the second housing 54, the user is not required to disengage the connector assembly 78 to disconnect the first housing 50 from the second housing 54. Further, neither the NIRCOS solenoid nor the manual release cable need to be disconnected when disconnecting the first housing 50 from the second housing 54.

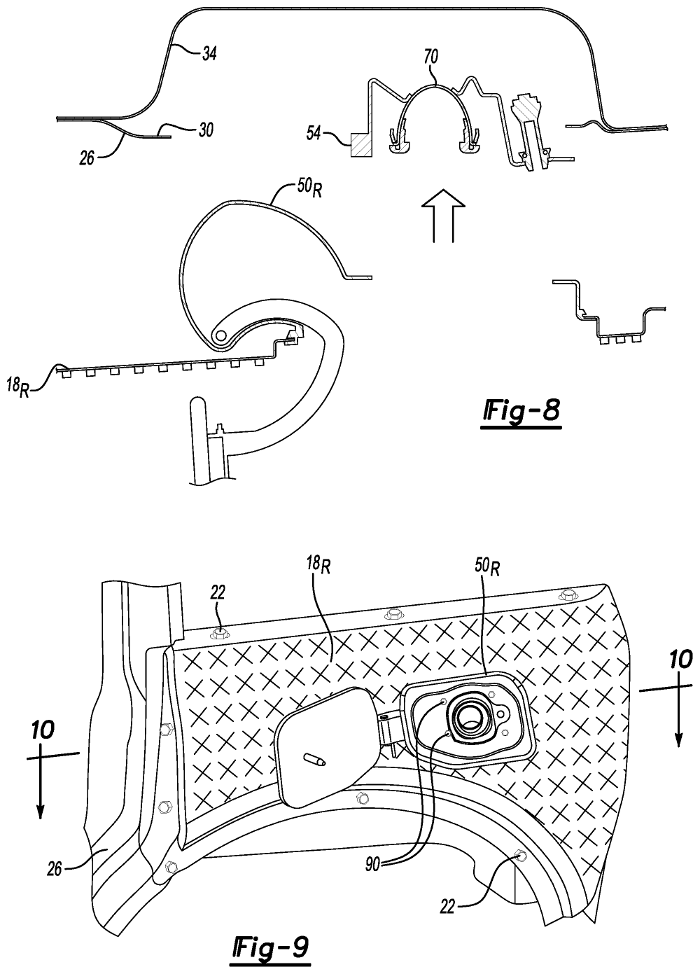

After removing the outer panel 18 and the first housing 50, a user can move a replacement panel 18_{R} and a replacement first housing 50_{R} toward the vehicle 10 as shown in FIG. 8. Alignment features extending from an inwardly facing side of the first housing 50_{R} could engage with corresponding alignment features of the second housing 54 to facilitate aligning the first housing 50_{R} relative to the second housing 54 during assembly. The alignment features could include ribs received within grooves, for example.

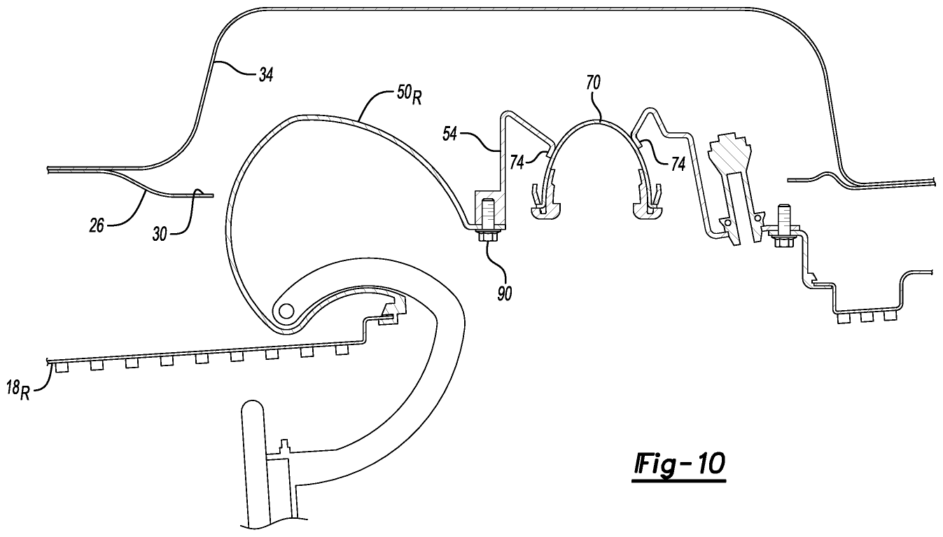

The user can secure the fuel inlet fasteners 90 to connect the replacement first housing 50_{R} to the second housing 54, and secure the panel fasteners 22 to connect the replacement panel 18_{R} to the inner panel 26. The replacement first housing 50_{R} is then secured to the replacement panel 18_{R}. When secured, the vehicle 10 includes the replacement panel 18_{R} and replacement first housing 50_{R} as shown in FIGS. 9 and 10. The second housing 54 is not replaced in this example.

Features of some of the disclosed examples include a fuel inlet assembly having a modular-type design that facilitates removal and replacement of an outer panel associated with the fuel inlet assembly. The fuel inlet assembly has first and second housings that can be disconnected from outside the outer panel, which can simplify removal of the outer panel associated with the fuel inlet assembly.

The preceding description is exemplary rather than limiting in nature. Variations and modifications to the disclosed examples may become apparent to those skilled in the art that do not necessarily depart from the essence of this disclosure. Thus, the scope of legal protection given to this disclosure can only be determined by studying the following claims.

What is claimed is:

1. A vehicle assembly, comprising:
a first and a second housing of a fuel inlet assembly, the first housing securable to an outer panel of a vehicle; and
at least one fuel inlet fastener that connects together the first and second housings, the at least one fuel inlet fastener configured to be accessed through a fuel inlet aperture of the outer panel to disconnect the first housing from the second housing.

2. The vehicle assembly of claim 1, further comprising a fuel door pivotably secured to the first housing.

3. The vehicle assembly of claim 2, wherein the fuel door is lockable in when in a closed position.

4. The vehicle assembly of claim 1, further comprising a fuel inlet pipe at least partially received within the second housing.

5. The vehicle assembly of claim 1, wherein the first housing is an outer housing and the second housing is an inner housing.

6. The vehicle assembly of claim 1, wherein the first housing is clipped to the outer panel to secure the first housing to the outer panel.

7. The vehicle assembly of claim 1, wherein the first housing can be removed from the vehicle with the outer panel when the first housing is disconnected from the second housing.

8. The vehicle assembly of claim 1, wherein the outer panel is a rear quarter panel of the vehicle.

9. The vehicle assembly of claim 1, further comprising a connector assembly mounted on the second housing such that the first housing can be disconnected from the second housing without decoupling the connector assembly.

10. The vehicle assembly of claim 1, wherein the at least one fuel inlet fastener comprises at least one mechanical fastener.

11. A panel removal method, comprising:
disconnecting a first and second housing of a fuel inlet assembly through a fuel inlet aperture in an outer panel of a vehicle; and
removing the outer panel and the first housing from the vehicle.

12. The outer panel removal method of claim 11, further comprising, prior to the removing, disengaging a plurality of panel fasteners that secure the outer panel to the vehicle.

13. The outer panel removal method of claim 11, wherein the disconnecting includes disengaging at least one fuel inlet fastener that connects together the first and second housings.

14. The outer panel removal method of claim 13, further comprising disengaging the at least one fuel inlet fastener without directly interfacing with an area behind the first housing.

15. The outer panel removal method of claim 14, wherein the at least one fuel inlet fastener comprises at least one mechanical fastener.

16. The outer panel removal method of claim 11, further comprising installing a replacement outer panel and a replacement first housing, the installing including securing the replacement first housing to the second housing.

17. The outer panel removal method of claim 11, wherein the first housing is secured to the outer panel during the removing.

18. The outer panel removal method of claim 11, wherein the first housing is snap-fit to the outer panel during the removing.

19. The outer panel removal method of claim 11, wherein the first housing is an outer housing that is secured to the outer panel, and the second housing is an inner housing that interfaces directly with a fuel pipe.
